(19) United States
(12) Patent Application Publication
(10) Pub. No.: US 2010/0050615 A1
(43) Pub. Date: Mar. 4, 2010

(54) Efficient Release of Ammonia from a Solid Ammonia Storage Medium

(75) Inventors: Tue Johannessen, Glostrup (DK); Henning Schmidt, Soborg (DK); Jens Kehlef Norskov, Holte (DK); Claus Hviid Christensen, Lynge (DK)

Correspondence Address: FROST BROWN TODD, LLC, 2200 PNC CENTER, 201 E. FIFTH STREET, CINCINNATI, OH, 45202, US

(73) Assignee: Gladsaxevej 363, Soborg (DK)

(21) Appl. No.: 12/374,448

(22) PCT Filed: Jul. 19, 2007
(86) PCT No.: PCT/EP2007/006447

§ 371 Date: Nov. 16, 2009

(30) Foreign Application Priority Data
Jul. 20, 2006 (DK) PA 2006 00999

(51) Int. Cl. B01D 53/94; F01N 3/20; B01D 53/90; C01C 1/02

(52) U.S. Cl. 60/295; 422/177; 423/352

(57) ABSTRACT

Solid metal ammine complexes are applied for safe and high-density storage of ammonia to be released for use as reducing agent in selective catalytic reduction of NOₓ in exhaust gases or as an energy carrier for fuel cell applications. The compositional formula of the metal ammine complexes is M(NH₃)ₙX_{z}, where M^{z+} represents one or more metal ions capable of binding ammonia, X represents one or more anions, n is the coordination number (from 2 to 12), and z the valency of the metal ion (and thus the total number of compensating anion charges). Ammonia is released by controlled dosing of water into the storage container whereby ammonia is released because water replaces ammonia on the active sites capable of binding ammonia. Consequently, ammonia can be released without applying a normal thermal desorption of ammonia and the operating temperature of the system is reduced as well as the energy needed for releasing ammonia.

### BACKGROUND OF THE INVENTION

1. Field of the Invention

This invention relates to the use of ammonia containing material, particularly metal ammine complexes, for storage of ammonia in solid form and for systems utilizing the solid storage material for controlled delivery of ammonia by releasing ammonia in a controlled manner using controlled dosing of water in order to replace ammonia in the crystal lattice with water.

Upon release, ammonia may be used as the reducing agent in selective catalytic reduction (SCR) of NOₓ in exhaust gases from combustion processes.

Other applications using the released ammonia are mobile or portable fuel cell units that can be operated directly on ammonia or on hydrogen made available by catalytic decomposition of ammonia into hydrogen and nitrogen. The present invention may also be applied as ammonia storage/delivery concept in special chemical synthesis routes or other applications where storage of liquid ammonia is too hazardous.

2. Description of the Related Art

Ammonia has a potential rope both as indirect hydrogen carrier for fuel cell applications and also as reductant in the selective catalytic reduction of NOx from e.g. internal combustion engines (lean-burn gasoline or diesel engines). However, the use and handling of ammonia as liquid ammonia stored in high-pressure vessels is not acceptable for normal end-user applications. Therefore, new methods safe and dense storage of ammonia has great industrial relevance in several fields of use.

Current environmental regulations necessitate the use of catalysts in the treatment of exhaust gas from automotive vehicles, boilers and furnaces for control of NOₓ emissions. Particularly, vehicles equipped with diesel or other lean burn (gasoline) engines offer the benefit of improved fuel economy, but catalytic reduction of NOₓ using conventional car exhaust catalysts (three-way catalyst) is not feasible because of the high oxygen content in the exhaust gas. Instead, selective catalytic reduction (SCR) has proven useful for achieving the required low levels of NOₓ in the exhaust gas both in stationary and mobile units. In such systems NOₓ is continuously removed from the exhaust gas by injection of a reductant into the exhaust gas prior to entering an SCR catalyst capable of achieving a high conversion of NOₓ.

So far, the most efficient reductant has been ammonia, which is usually introduced into the exhaust gas by controlled injection either of gaseous ammonia (delivered from liquid ammonia stored under pressure), aqueous ammonia or indirectly as urea dissolved in water. In all cases, the amount of reductant being dosed has to be very precisely controlled. Injection of too high amount of reductant will cause a slip of ammonia in the exhaust gas whereas injection of a too small amount of reductant causes a less than optimal conversion of NOₓ.

In many mobile units, the only available technology is to use an aqueous solution of urea as the reductant since in this way potential hazards or safety issues relating to the transport of liquid ammonia are eliminated. However, there are several disadvantages related to the use of aqueous urea as the reductant. First of all, the use of urea solutions requires that a relatively large storage volume is available in order to enable transport sufficient amounts of ammonia. In typical systems, about 30 wt urea solution is used only to transport water. During operation the urea solution is sprayed into the exhaust gas, the droplets evaporate and the urea decomposes more or less selectively to ammonia (one molecule of urea forms two molecules of NH₃ and one CO₂) which by mass is roughly 50 wt % of ammonia in the urea molecule. Similar concentrations of ammonia can be achieved using aqueous solutions of ammonia as reductant. Furthermore, for technologies using aqueous solutions a specially designed spray nozzle combined with a precision liquid pump is required to ensure that a) the aqueous urea is delivered to the exhaust system at a desired (and dynamically changing) flow rate and b) that the solution is efficiently dispersed as fine droplets in the gas phase before entering the catalyst. Furthermore, the aqueous solutions might freeze in extreme weather conditions, or the urea solution may simply form precipitates, which might block the dosing system, e.g. the nozzle. Therefore, all lines have to be heated. Furthermore, the decomposition of urea may not proceed as desired. There may be undesired side-reactions giving by-products in the form of solid deposits of polymers (melamine) and these side reactions also make it difficult to dose a very specific amount of ammonia since the amount of free ammonia released from a given amount of urea can vary according to the decomposition conditions.

Altogether, these difficulties may limit the possibilities of using SCR technology in pollution abatement, particularly in connection with mobile units. To circumvent these difficulties, the present invention devises an alternative method for transporting and dosing ammonia to exhaust gases prior to entering SCR catalyst systems.

As disclosed in applicant's copending application No. PCT/DK 2005/00516, incorporated herein by reference, metal ammine salts can be used as a solid storage media for ammonia which in turn may be used as the reductant in selective catalytic reduction to reduce NOₓ emissions from automotive vehicles, boilers and furnaces. Thus, the metal-ammine salt constitutes a solid storage medium for ammonia, which represent a safe and practical option for storage and transportation of ammonia. Usually, ammonia is released thermally from the preferred metal ammine salt by external heating, see e.g. European Patent No. EP 0 932 440 B1. The metal ammine salt is held in a container from which the released ammonia is dosed through a controllable valve directly into the exhaust gas in the desired proportion. Between the container and the valve, there may be a small buffer volume to increase the controllability of the system. Useful metal ammine salts have the general formula M(NH₃)ₙX_{z}, where M^{z+} is one or more metal ions capable of binding ammonia (For example M may be Li, Mg, Ca, Sr, V, Cr, Mn, Fe, Co, Ni, Cu, Zn, etc.), n is the coordination number (2-12), and X is one or more anions, where representative examples of X are F, Cl, Br, I, SO₄, MoO₄, PO₄ etc.

During release of ammonia, the original metal-ammine salt M(NH₃)ₙX_{z} is gradually transformed into M(NH₃)ₘX_{z} with m<n. When all the desired ammonia has been released, the resulting M(NH₃)ₘX_{z} can usually be converted back into M(NH₃)ₙX_{z} by an absorption treatment with an ammonia-containing gas stream.

Typical ammonia contents of the metal ammine complexes are in the range of 20-60 wt %, preferably above 30 wt %. As an example, a typical and inexpensive compound such as Mg(NH₃)₆Cl₂ contains 51.7 wt % ammonia. Another example is Ca(NH₃)₈Cl₂, which contains 55 wt % NH₃. Using a compaction method such as the one disclosed in applicant's copending application No. PCT/DK 2006/00059, incorporated herein by reference, it is possible to obtain an ammonia density per unit volume above 90% of that of liquid ammonia. This is a unique combination of high density and safety in ammonia handling.

Using applicant's technology enables storage of ammonia at significantly higher densities (both on a volume and a weight basis) than both aqueous ammonia and aqueous urea solutions. For several metal ammine salts it is possible to release all ammonia and then transform the resulting material back into the original metal ammine salt in a large number of cycles. This obviously constitutes preferred embodiments. Additionally, the ammonia is directly delivered into the exhaust in the form of a gas, which is an advantage in itself—both for the simplicity of the flow control system and for an efficient mixing of reducing agent, ammonia, with the exhaust gas—but it also eliminates potential difficulties related to blocking of the dosing system because of precipitation or impurities in a liquid-based system.

For mobile units, it is particularly useful to hold the metal ammine in a container that can be easily separated from mobile unit and replaced by a new metal ammine container. In preferred embodiments, the metal ammine containers are recycled and recharged with ammonia in a separate recharging unit or recharging facility.

Usually, ammonia is released from absorbed state by heating the material by electrical resistance in heating elements or by using the heat from e.g. an exhaust gas. In such a process, ammonia is made available and delivered to the desired location by generating a gauge pressure of ammonia by desorption in the storage container order to control the flow of ammonia through a valve and further on into e.g. an exhaust gas line. When ammonia is thermally desorbed from the solid to generate an elevated ammonia supply pressure, the operating temperature of the desorption process is increased significantly due to the thermodynamic relation between vapour pressure and temperature and the system is less safe due to the availability of desorbed ammonia at a pressure above the standard pressure of the surroundings.

In the present invention, the method of storage and delivery is made even more safe and versatile by using water to release the ammonia, which bound in the solid storage medium. Ammonia is coordinated inside the crystal lattice of a metal ammine salt (the electron lone-pair of ammonia molecules is “facing” the metal cation) but water can replace the position of ammonia in a similar manner due to the same nature of coordination chemistry of electron lone-pairs. Since water is binding slightly stronger to the crystal lattice of the solid, one can extract ammonia without providing any thermal energy of desorption. Therefore, the present invention provides a method for non-thermal release of ammonia from a solid ammonia-storage material using inexpensive and readily available water. In many possible applications, water is readily available. Examples of combinations of ammonia storage/delivery in integrated systems are:
Systems for NOx removal in automotive units using ammonia in a selective catalytic reduction reaction where ammonia is made available by controlled injection of water into the storage container. Water is present already in the humid exhaust gas or may be taken from a separate fluid container.
Fuel cell system utilizing ammonia as an energy carrier. Fuel cell systems can convert hydrogen into electricity and the waste product is water. Water may be delivered back to the storage container in order to give “free” release of ammonia. Before being fed to the fuel cell, ammonia may be catalytically decomposed into hydrogen and nitrogen where hydrogen is oxidized in the fuel cell.
Processes or system where ammonia is used in e.g. a chemical reaction. Ammonia can be made available from a safe and dense solid storage medium using controlled dosing of water stored in a separate tank or by using water as a waste product from the process or system.

After release of ammonia governed by the dosing of water, ammonia is dosed into the desired location/process/fluid/gas by controlling a flow of ammonia from the container—through an optional buffer volume—using an adjustable valve.

### SUMMARY OF THE INVENTION

The present invention relates to a method of storing and delivering ammonia, said method comprising the steps of:

(a) providing a container;

(b) placing ammonia containing solid material capable of storing ammonia by absorption/desorption in said container;

(c) effecting controlled ammonia release by dosing water into the container in a controlled manner.

In a second aspect the invention relates to a system for removing NOx from an oxygen-containing exhaust gas of a combustion engine or combustion process, the system comprising:

(a) a container with a solid material capable of storing ammonia by absorption/desorption inside said container;

(b) means for dosing water into the container thereby effecting ammonia release.

(c) means for introducing the released gaseous ammonia from the container into an exhaust gas,

(d) a catalyst for reducing NOx by reaction with the dosed ammonia, and

(e) means for controlling the amount of ammonia to give an optimal ratio between NOx and ammonia in order to obtain high NOx conversion while minimizing ammonia slip from the gas down-steam from catalyst.

In a third aspect the invention relates to a device for providing ammonia for a selective catalytic reduction of NOx in an oxygen-containing exhaust gas of a combustion engine or combustion process by using gaseous ammonia and a reduction catalyst, the device comprising:

(a) a container for containing a solid ammonia storage material;

(b) means for dosing water into the container thereby effecting ammonia release.

(c) means for introducing the released gaseous ammonia from the container into an exhaust gas,

(d) a catalyst for reducing NOx by reaction with the dosed ammonia, and

(e) means for controlling the amount of ammonia to give an optimal ratio between NOx and ammonia in order to obtain high NOx conversion while minimizing ammonia slip from the gas down-steam from catalyst.

In a forth aspect, the invention relates to the use of dosing of water into a container with a solid ammonia storage material capable of storing ammonia for effecting ammonia release.

### BRIEF DESCRIPTION OF THE DRAWINGS

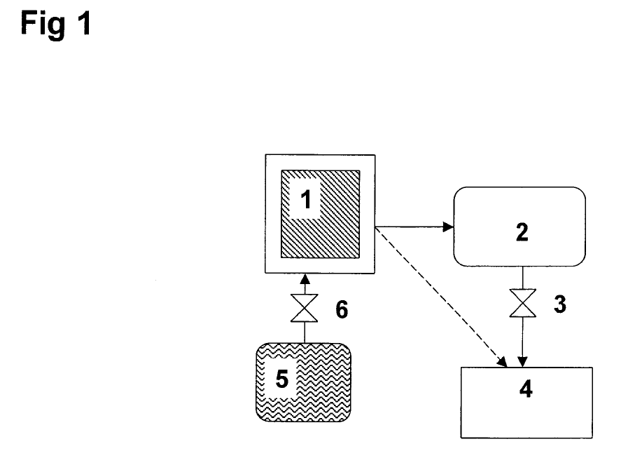

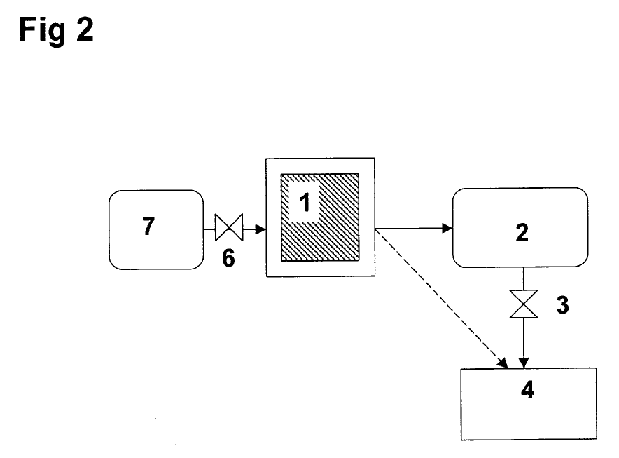

The invention is disclosed more in detail with reference to the drawings in which FIGS. 1 and 2 both show different embodiments of devices of the invention.

### DETAILED DESCRIPTION OF THE PRESENT INVENTION

Ammonia can be stored safely and efficiently as a solid material—more specifically as metal ammine complexes of the general formula Mₐ(NH₃)ₙX_{z}, wherein M is one or more cations selected from alkaline earth metals, and/or one or more transition metal ions, such as Mn, Fe, Co, Ni, Cu, and/or Zn, X is one or more anions, a is the number of cations per salt molecule, z is the number of anions per salt molecule, and n is the coordination number of 2 to 12.

Such complexes may bind water molecules more strongly to the material than the already absorbed ammonia molecules. Consequently, ammonia may be released—and thereby released—by forcing ammonia out of storage material by a controlled dosing of water. The source or water or whether water is dosed as a liquid or gas is not crucial. In both cases, the absorption of water into the crystal structure will result in release of ammonia. Water may be dosed via a spray or atomization or similar kinds of processes generating droplets. Also, it may be provided by passing a water-saturated (partly saturated, if desired) carrier gas through the storage container. Using humid air may also be a way of providing water. Using a water-containing exhaust gas from combustion processes or fuel cells is also considered embodiments of the invention.

Using the present invention, a heating of the storage material in order to release ammonia at a gauge desorption pressure is circumvented.

The storage material may be regenerated by exposing the water-containing complex to high partial pressure of ammonia or even by direct exposure to liquid ammonia.

Examples of suitable storage materials are chloride or sulphate salts of alkaline earth metals, and/or one or more transition metal ions, such as Mn, Fe, Co, Ni or Cu. Specific examples of well-suited materials are chloride or sulphate salts of Mg, Ca, Sr, i.e. MgCl₂, CaCl₂, SrCl₂, MgSO₄, CaSO₄, SrSO₄.

In applicant's co-pending applications WO 2006/012903 and PCT/DK 2006/000059, incorporated herein by reference, is disclosed methods and devices for ammonia storage and delivery using compacted metal ammine salts. According to these applications the use of a solid storage material with a low equilibrium pressure of ammonia (preferably below 0.1 bar at room temperature) gives superior safety of the storage method. Using the method of compaction, the saturated material into e.g. dense rods gives a very high ammonia density compared to e.g. granulated material. The ammonia densities in such compacted structures give an ammonia density above 90% of the volumetric ammonia density of liquid ammonia.

The present invention is useful in any system requiring safe and controlled delivery/dosing of ammonia from a high-density solid storage material containing ammonia. The invention is useful both as a general method but also specifically for devices based on ammonia delivery from a solid ammonia storage medium.

The invention is useful for different kinds of formulated solid forms of ammonia storage materials, e.g. solid rods/cylinders/blocks with low porosity and also for granulated storage material with a porosity generated from the loss in packing density due to the space between the individual granules.

The present invention is particular useful in the controlled delivery of ammonia to an exhaust gas containing NOx for the purpose of removing NOx by the well-known selective catalytic reduction (SCR) process.

The present invention is useful for both mobile and stationary SCR-application but is considered particularly useful in the delivery of ammonia for automobiles, trucks and ships fuelled on diesel or using lean-burn gasoline or even ammonia-fuelled engines/fuel cells.

The present invention is also useful for delivery of ammonia to solid oxide fuel cells (SOFC), which can operate on a number of fuels, e.g. hydrogen, methane but also directly on gaseous ammonia. It is also useful for the delivery of ammonia to an integrated ammonia decomposition unit for the production of hydrogen, which subsequently may be used as fuel in a PEM Fuel Cell, an alkaline fuel cell or a molten carbonate fuel cell.

### DESCRIPTION OF DRAWINGS

The invention is now explained more in detail with reference to the drawings showing preferred embodiments of the invention.

FIGS. 1 and 2 illustrate the use of the present invention in several applications.

FIG. 1. The storage unit containing the (optionally compacted) metal ammine salt (1) is exposed to water from a container (5) through an optional controlling valve or nozzle (6). When ammonia is released, it flows to an optional buffer volume (2) and further to an ammonia consuming unit (4) through an optional control valve (3). The ammonia-consuming unit may be a chemical process requiring ammonia such as an exhaust system which requires ammonia in order to carry out NOx reduction by having a DeNOx catalyst that removed NOx by adding ammonia as the reductant. The ammonia-consuming unit (4) may also be a fuel cell system capable of running directly on ammonia as fuel or with an ammonia reformer that converts ammonia into hydrogen or nitrogen where at least the hydrogen is fed to a fuel cell.

FIG. 2. The storage unit containing the (optionally compacted) metal ammine salt (1) is exposed to water by introducing a humid gas through an optional controlling valve or nozzle (6) into the storage container. When ammonia is released, it flows to an optional buffer volume (2) and further to an ammonia consuming unit (4) through an optional control valve (3). The humid gas may be taken from the atmosphere or as indicated in the figure from a container or process (7) where water is present as a vapour in a carrier gas. The generation of water vapour or humid gas may take place in a chemical reaction or a combustion process and consequently the gas from (7) may be an exhaust gas from a combustion engine or the product gas of a fuel cell unit.

The ammonia-consuming unit (4) may be a chemical process requiring ammonia such as an exhaust system which requires ammonia in order to carry out NOx reduction by having a DeNOx catalyst that removed NOx by adding ammonia as the reductant. The ammonia-consuming unit may also be a fuel cell system capable of running directly on ammonia as fuel or with an ammonia reformer that converts ammonia into hydrogen or nitrogen where at least the hydrogen is fed to a fuel cell.

It will be obvious to the skilled in the art how to build systems and devices according to the present invention from units, components and/or assemblies known per se considering the specific system or device and the contemplated use.

1. A method of storing and delivering ammonia, said method comprising the steps of:
(a) providing a container;
(b) placing ammonia containing solid material capable of storing ammonia by absorption/desorption in said container;
(c) effecting controlled ammonia release by dosing water into the container in a controlled manner.

2. A method according to claim 1, wherein the ammonia containing material initially is saturated with ammonia.

3. A method according to claim 1, wherein the water needed for ammonia release is provided from a separate water container.

4. A method according to claim 1, wherein the water needed for effecting ammonia release is provided as a product of a chemical reaction, a combustion reaction, from the humid exhaust of a fuel cell unit or from the humid exhaust gas of an automotive unit operating on hydro-carbon fuels or on synthetic fuel.

5. A method according to claim 1, wherein the water needed for effecting ammonia release is provided by spraying or atomizing water as fine droplets into the storage container.

6. A method according to claim 1, wherein the water needed for ammonia release is provided by passing a humid gas through the storage container thereby replacing some or all of the water content in the gas by ammonia released from the solid.

7. A method according to claim 1, wherein the ammonia containing material is a metal ammine complex.

8. A method according to claim 7, wherein the ammonia storage material is a salt of the general formula: Mₐ(NH₃)ₙX_{z}, wherein M is one or more cations selected from alkali metals, alkaline earth metals, and/or transition metals, or combinations thereof, X is one or more anions selected from fluoride, chloride, bromide, iodide, nitrate, thiocyanate, sulphate, molybdate, and phosphate ions, a is the number of cations per salt molecule, z is the number of anions per salt molecule, and n is the coordination number of 2 to 12.

9. A method according to claim 8, wherein the ionic salt is either chloride or sulphate salts of Mg, Ca, Sr or mixtures thereof.

10. A method according to claim 1, wherein the saturated ammonia containing material is compacted to a dense block, rod, cylinder, ring or edged unit, with a density above 70% of the theoretical maximum skeleton density of the saturated solid material before placing in the container.

11. A method according to claim 1, where the release rate of ammonia is determined by control of the dosing rate of water into the storage container.

12. A method according to claim 11, wherein the delivery of ammonia is further controlled by reduction valves, flow controllers, valves or similar type of equipment.

13. A method according to claim 1, wherein the released ammonia is used in selective catalytic reduction of NOx in exhaust gases from combustion processes.

14. A method according to claim 13, wherein the released ammonia is used in NOx emission reduction from stationary and mobile combustion engines fuelled by diesel, petrol, natural gas or any other fossil fuels.

15. A method according to claim 13, wherein the released ammonia is used in NOx emission reduction from stationary or mobile combustion engines fuelled by methanol, ethanol, hydrogen, methane, ethane or any other bio- or synthetic fuel.

16. A method according to claim 13, wherein the released ammonia is used in NOx emission reduction from stationary or mobile power plants fuelled by coal, natural gas, oil or any other fossil fuels.

17. A method as claimed in claim 1, wherein the released ammonia is fed to an ammonia-fuelled fuel cell as fuel.

18. A method as claimed in claim 1, wherein the released ammonia is fed to an ammonia decomposition reactor wherein ammonia is decomposed to nitrogen and hydrogen, and at least the hydrogen is fed to a hydrogen-fuelled fuel cell as fuel.

19. A system for removing NOx from an oxygen-containing exhaust gas of a combustion engine or combustion process, said system comprising:
(a) a container with a solid material capable of storing/delivering ammonia by absorption/desorption inside said container;
(b) means for dosing of water into the container thereby effecting ammonia release,
(c) means for introducing the released gaseous ammonia from the container into an exhaust gas,
(d) a catalyst for reducing NOx by reaction with the dosed ammonia, and
(e) means for controlling the amount of ammonia to give an optimal ratio between NOx and ammonia in order to obtain high NOx conversion while minimizing ammonia slip from the gas down-steam from catalyst.

20. A device for providing ammonia for a selective catalytic reduction of NOx in an oxygen-containing exhaust gas of a combustion engine or combustion process by using gaseous ammonia and a reduction catalyst, said the device comprising:
(a) a container with a solid material capable of storing/delivering ammonia by absorption/desorption inside said container;
(b) means for controlled dosing of water into the container thereby effecting ammonia release,
(c) means for introducing the released gaseous ammonia from the container into an exhaust gas,
(d) a catalyst for reducing NOx by reaction with the dosed ammonia, and
(e) means for controlling the amount of ammonia introduced into the exhaust line, depending on the operating conditions of the engine.

21. A device according to claim 20 for use for selective catalytic reduction of NOx in exhaust gases, when applied to automobiles, trucks, trains, ships or any other motorized machine.

22. A device according to claim 20 for use for selective catalytic reduction of NOx in exhaust gases when applied to power plants generating electricity.

23. (canceled)

24. (canceled)

25. (canceled)
